(19) United States
(12) Patent Application Publication
(10) Pub. No.: US 2002/0052902 A1
(43) Pub. Date: May 2, 2002

(54) Method to convert unicode text to mixed codepages

(75) Inventor: Joachim Manfred Bauer, Bocblingen (DE)

Correspondence Address: William A.Kinnaman, Jr., IBM Corporation- M/S P386, 2455 South Road, Poughkeepsie, NY, 12601, US

(73) Assignee: International Business Machines Corporation, Armonk, NY

(21) Appl. No.: 09/842,336

(22) Filed: Apr. 25, 2001

(30) Foreign Application Priority Data
Oct. 30, 2000 (DE) 00108881.8

(51) Int. Cl. G06F 17/00

(52) U.S. Cl. 707/536; 707/531

(57) ABSTRACT

The present invention relates to method and system for converting a source string being encoded according to the Unicode standard into a target string which is to be encoded according to mixed codepages. It is proposed to associate a predetermined priority with each sub-codepage, and converting the characters strictly according to said priority sequence without using a mapping table in order to find out in which of the plurality of sub-codepages the target character and its encoding is stored. Advantageously, the sub-codepage which comprises the most frequently used characters is associated with the highest priority, and that one with the most rarely used characters is associated with the lowest priority.

### BACKGROUND OF THE INVENTION

1. Field of the Invention

The present invention relates to a method and system for converting between character codes associated with computer-readable characters. In particular, it relates to such method and system for converting a source string encoded according to the Unicode standard into a target string which is to be encoded according to mixed codepages.

2. Description of the Related Art

Computers and other electronic devices typically use text to interact with users. The text is usually displayed on a monitor or some other type of display device. Because the text must be represented in digital form inside the computer or other electronic device, a character set encoding must be used. Generally speaking, a character set encoding operates to encode each character of the character set with a unique digital representation. The characters (which are encoded) correspond to letters, numbers and various text symbols. They are assigned numeric codes for use by computers or other electronic devices. The most popular character set for use with computers and other electronic devices is the American National Standard Code for Information Interchange (ASCII). ASCII uses 7-bit sequences for its encodings. In other countries, different character sets are used. In Europe, the dominant character encoding standards are the ISO 8859-X family, especially ISO 8859-1 (called “Latin-1”) developed by the International Standards Organization (ISO). In Japan, the dominant character encoding standard is JIS X0208, where JIS refers to the Japanese Information Standard and was developed by the Japan Standards Association (JSA). Examples of other existing character sets include Mac™ OS Standard Roman encoding (by Apple Computer, Inc.), Shift-JIS (Japan), Big5 (Taiwan), and many more.

The above-mentioned character sets are stored in a so-called codepage which is a kind of table disclosing the coding of each of the characters making up the character set. Thus, for each character its associated numerical code is given such that a unique mapping exists between the two. Most codepages associate a numerical code of one-byte length for each character. But there are codepages having a numerical code of more than that, for example of two-byte or three-byte length. Codepages comprising characters having all the same code length are called simple codepages.

In order to better accommodate the complexity of the individual language-specific national requirements so-called mixed codepages exist as well. A mixed codepage comprises at least two sub-codepages the coding of which may differ in length. Such sub-codepages are called codesets as well. They are numbered from 0 up to 3. The mixed Japanese codepage IBM-33722, for example, comprises the codesets IBM-895 (1 byte, codeset 0), IBM-952 (2 bytes, codeset 1), codepage IBM-896 (escape 8E+1 byte, codeset 2) and IBM-953 (escape 8F+2 bytes, codeset 3).

With the steadily increasing process of globalization of business and networks and with the further increasing influence of the Internet which connects between virtually all nations all over the world any conversion of data between computers using different kinds of codepages must be as fast as possible and, optionally, as simple as possible.

In order to simplify such code conversions the so-called Unicode standard has been developed and is meanwhile internationally recognized. Unicode offers a single scheme for representing all existing codesets. The design of the Unicode encoding scheme is independent of the design of basic text processing algorithms, with the exception of directionality. Unicode implementations are assumed to contain suitable text processing and/or rendering algorithms. Any character encoded according to the Unicode standard is represented by a two-byte-long numerical code.

The problem now is to find an efficient way to convert from the Unicode standard to the above mentioned mixed codepages, i.e. a source string is given represented by the Unicode standard and is desired to be converted very simply and very quickly into a code system which comprises a plurality of codepages, for example a plurality of four as was mentioned above.

A prior art converting method from Unicode to multiple codepages is disclosed in U.S. Pat. No. 5,793,381. Such code conversion system maps a single source character or a sequence of characters to either a single target character or a sequence of target characters by looking up in a mapping table the location of the associated target character. When reading a source character the mapping table is accessed for determining which of the sub-codepages shall be used for code conversion. A particular sub-codepage is found which is continued to be used for code conversion until a source character is found in the input character string which can not be converted with the sub-codepage. In this case the auxiliary mapping table is reaccessed in order to find the right sub-codepage. Additionally, the prior art code conversion system includes a fallback handling operating with the mapping table to identify one or more characters in the target encoding that are able to be used as a fallback mapping for the text element in cases where the lookup handler has been unable to identify one or more characters in the target encoding for the text element.

This prior art approach, however, uses an additional lookup table that makes it slower and more complicated than necessary.

### SUMMARY OF THE INVENTION

It is thus an object of the present invention to provide a method and system for code conversion from Unicode text to mixed codepages which can be run with better performance.

This and other objects of the invention are achieved by the features stated in the appended independent claims. Further advantageous arrangements and embodiments of the invention are set forth in the respective subclaims.

Briefly summarizing the basic concepts of the present invention it is proposed to associate a predetermined priority with each sub-codepage, and converting the characters strictly according to such priority sequence without using a mapping table in order to find out in which of the plurality of sub-codepages the target character and its encoding is stored. Advantageously, the sub-codepage containing the most frequently used characters is associated with the highest priority, while the one with the most rarely used characters is associated with the lowest priority. Thus, in a case of four sub-codepages a priority sequence between the sub-codepages can be established. Each priority is a measure of the probability of finding a particular character in the respective sub-codepage.

Beside this fundamental approach it is further proposed for the case when a character has not been found in a particular sub-codepage to access the sub-codepage having the highest priority which has not yet been accessed for such character.

Applying the above-mentioned measures of the present invention yields the following advantages:

First, the performance is remarkably increased compared to the prior art conversion method mentioned above because there is no separate mapping table which has to be accessed each time a character is not found in the currently used sub-codepage.

Second, the auxiliary mapping table need not be created at all. This saves a lot of work.

Third, the priority sequence given to the plurality of sub-codepages can be established such that country-specific knowledge about the language is exploited. Thus, the conversion method of the present invention is easily adaptable to the particularities imposed by a particular, country-specific codepage system.

Dependent on a respective individual case the above mentioned priority sequence can be alternatively dynamically changed from a standard to an individual setting before running the code conversion in order to adapt the code conversion method of the present invention to specific requirements imposed by a specific text to be converted when it is known in advance that the text is not representative of the average. The new priority sequence might be given for example in the header of the file to be converted.

A further remarkable advantage of the method of the present invention is that it offers a concept which is open to exploit the specific advantage of modern computer systems that hardware instructions may be used which process a plurality of characters instead of only one at a time. Such modern hardware instructions need a linear table for looking up the target characters without an additional checking access to any kind of mapping table.

The present invention can be advantageously used with the Internet when any code conversion is required. Further, the tool of the present invention may be incorporated in a data base application when some contents of the data base are likely to be converted from a Unicode text to mixed codepages.

When the method of the present invention is applied in a case in which the probability of finding a particular character in one of the plurality of sub-codepages is the same for all sub-codepages a statistical mean value of only 2 additional accesses are required when four sub-codepages exist. This value reduces to 1.5 for three sub-codepages and reduces to 1 for the case with two sub-codepages. In a case for Japanese EUC-tables in which 70% of all characters are found in codeset 1, 30% are found in codeset 0 and less than 1% are found in the remaining codesets 2 and 3, the statistical mean value is a little more than 1.

Further, the present invention can advantageously be incorporated at least partly in a hardware implementation directly burnt-in into a hardware chip. Such a chip means then comprises hardware circuits implementing and reflecting at least parts of the steps of the code conversion method of the present invention. Considering the steadily growing diversity of telecommunication devices and their steadily increasing function range including more and more technical features such a chip can then be used in a large variety of devices. In view of devices available today such a chip can be advantageously used in any device which forms part of any international communication. For example, routers in any kind of network, e.g., the Internet, set-top boxes for TV or radio receiving devices, particularly digital TV or radio, mobile phones, any kind of handheld computing and/or telecommunication device or any other device having an input interface for processing any foreign-language data.

### BRIEF DESCRIPTION OF THE DRAWINGS

The present invention is illustrated by way of example and is not limited by the shape of the figures of the accompanying drawings in which:

FIG. 1 is a schematic logical representation showing the basic elements of the method of the present invention;

FIG. 2 is a rough illustration in an arbitrarily chosen example showing for each of a plurality of 230 source characters in which of a plurality of 4 sub-codepages each character may be found;

FIG. 3 is a logical scheme showing the sequence of codeset accesses when a method is applied according to a preferred embodiment of the present invention during code conversion.

### DESCRIPTION OF THE PREFERRED EMBODIMENT

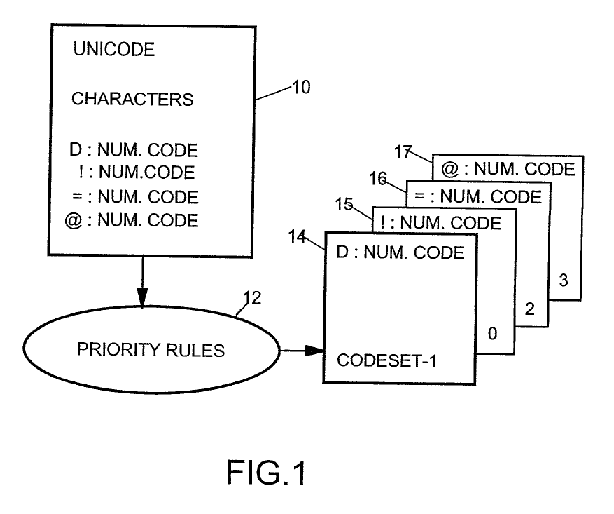

With general reference to the figures and with special reference now to FIG. 1, in box 10 the set of Unicode characters which are subjected to the conversion method of the present invention is symbolically represented.

According to a preferred embodiment of the method of the present invention, some priority rules 12 are established which establish some well-defined priority sequence between the plurality of sub-codepages used. The term ‘codeset n’, n being an integer number, which basically means the same as the term ‘sub-codepage n’, is sometimes used here. In the case depicted in FIG. 1 four sub-codepages denoted as codeset 1, 14, codeset 0, 15, codeset 2, 16 and codeset 3, 17 are used.

In box 10 four exemplarily selected characters are depicted the encoding of which is located each in a different separate sub-codepage, as shown on the right side of FIG. 1.

As shown in the drawing in each of the tables 10, 14, 15, 16, 17 the numerical code is stored for each character.

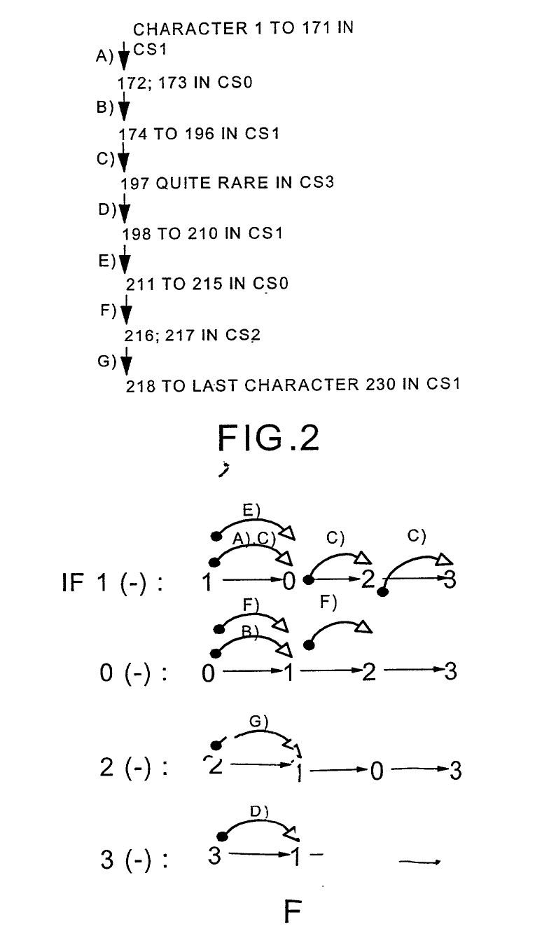

With reference now to FIG. 2 and 3 a preferred embodiment of the method of the present invention will be described in more detail in an exemplary code conversion from Japanese Unicode to mixed Japanese EUC sub-codepages.

Prior to starting the code conversion an already existing estimation for the Japanese EUC sub-codepages is used estimating that the sub-codepages in this special case are organized such that codeset 1 comprises nearly 70% of all occurring source characters, whereas codeset 0 comprises about 29%, codeset 2 comprises about 0.6% and codeset 3 comprises about 0.4% of the total of occurring characters. Said codeset probability distribution is depicted in FIG. 1 as well in so far as the most frequently used codeset 14 is depicted in front and the most rarely used one is depicted as the last set 17 of the ‘stack’ of codesets. The above-mentioned priority sequence is thus:

codeset 1, codeset 0, codeset 2, codeset 3.

In FIG. 2 a rough illustration in an arbitrarily chosen example is depicted showing for each of a plurality of 230 source characters in which of a plurality of four sub-codepages each character may be found.

A total of 230 source characters are to be converted in a single exemplary conversion process. It should be understood that the number of 230 is chosen quite small in order to improve clarity of the process.

The total of 230 source characters are thus comprised of the input set symbolically represented with reference sign 10 in FIG. 1. The new numerical code required to be issued by the method of the present invention is stored in the four sub-codepages 14, 15, 16, 17, see FIG. 1 right side as follows:

characters 1 to 171 in codeset 1,

characters 172, 173 in codeset 0,

characters 174 to 196 in codeset 1 again,

character 197 which is a quite rarely used one, is located in codeset 3,

characters 198 to 210 in codeset 1 again,

characters 211 to 215 are stored in codeset 0,

characters 216, 217 in codeset 2, which are quite rarely used as well, and

characters 218 to 230 in codeset 1.

The conversion scheme serially processes the above-mentioned source characters. In a preferred way to apply the method of the present invention, hardware instructions can be used, which process a plurality of characters at a time. An example for this is the IBM S/390 hardware instruction ‘Translate Two to One’, abbreviated as TRTO for converting a string comprised of 2-byte characters into an output buffer comprising 1-byte characters. Said hardware instruction takes arguments as follows:

the string to be converted,

the target buffer into which the converted string can be stored,

a character indicating that a particular input character can not be converted,

a conversion table which is addressed with the character to be converted and where the converted

character is stored at the thus addressed location.

For the sake of clarity, however, and in order to concentrate on the real core of the present invention the above described input character sequence is submitted to a single-character conversion process, i.e., a process which is treating each character separately.

According to a preferred feature of the present embodiment a set of processing rules are established which is derived from the above-mentioned priority sequence. Said processing rules are as follows:

1. Access the highest priority codeset first.

2. When a particular character can not be found in the highest priority codeset then continue with the codeset having the next lower priority and so on.

3. In case a character has not been found in a codeset: access the codeset having the highest priority which has not yet been accessed for this character.

Applying these rules yields the scheme given in FIG. 3.

FIG. 3 comprises four rows. The first row reflects the sequence of sub-codepages to be accessed subsequently if a particular character can not be found when starting with an access in sub-codepage 1, i.e., the sub-codepage having the highest priority. Thus, when a character can not be found in sub-codepage 1 sub-codepage 0 will be accessed for searching the current character. If said current character is found in sub-codepage 0 the process continues in said sub-codepage with the next character to be converted. For this next character the second row will be applied for search. Otherwise, if the above-mentioned current character can not be found in sub-codepage 0, then sub-codepage 2 will be accessed for further search. Then a corresponding scheme will be followed for sub-codepage 2:

If the current character is found in sub-codepage 2 the associated numerical code, i.e. the converted code, will be issued and the next character will be searched according to the third row depicted in FIG. 3. Otherwise, i.e. if the current character is not found in sub-codepage 2, the last sub-codepage 3 will be accessed for search. Then the character will be found and the search continues with the fourth row depicted in FIG. 3.

As can be appreciated from the above description according to said embodiment of the present invention the search always continues in the particular sub-codepage in which the last character was successfully detected.

With special reference to the second, third or fourth row the highest priority sub-codepage, here codepage 1 depicted with reference sign 14 in FIG. 1, is always accessed for the next character to be converted when in the respective current sub-codepage said next character could not be found.

With particular reference to the character string illustrated in FIG. 2 the way of processing i.e. of accessing the different sub-codepages will be described now in more detail. In both FIGS. 2 and 3 arrows are depicted denoted from A) to G) indicating respective access changes from one codeset to another codeset:

The search begins with an access to sub-codepage 1 because this is the highest priority one. Thus, character 1 is found and its numerical code is converted by outputting the numerical code stored in sub-codepage 1. Then the conversion process takes the second character as input and the same procedure is repeated because the second character is stored in sub-codepage 1, as well. The same applies in continuation until character number 172 is reached.

Said current character 172 can not be found in sub-codepage 1. Thus, as shown by arrow A) the sub-codepage 0 will be accessed next because it is the sub-codepage having the next highest priority. Incidentally, character 172 is found in sub-codepage 0. Thus, its numerical code will be issued as described above. Sub-codepage 0 will now be continued to be applied for character 173. Incidentally, as shown in FIG. 2 it is stored as well in sub-codepage 0. Then, character 174 is processed. This time this character is not found in codeset 0. Thus, the second row in FIG. 3 applies. As shown by arrow B) codeset 1 is reaccessed because the probability to find the character is the highest when searching in this codeset.

Incidentally, as shown again in FIG. 2 said character 174 is found in codeset 1 again. Thus, after issue the first row applies again. Characters 175 to 196 are processed as described above without changing the codeset.

Then, character 197 which is a quite rarely used character is not found in codeset 1. Thus, as shown by arrow C) in FIG. 3 codeset 0 is accessed and searched. Then, as it is not found therein codeset 2 is accessed and searched, and as it is not found therein, finally codeset 3 is accessed. Herein, character 197 is found and its numerical code is issued. Then the search continues in codeset 3.

Character 198 is not found in codeset 3. Thus, the fourth row depicted in FIG. 3 applies and as shown by arrow D) codeset 1 is accessed next. In here the search is successful for character 198 until character 211 can not be found. Thus, the first row applies again. As shown by arrow E) codeset 0 is accessed next. In codeset 0 characters 211 to 215 are found.

Character 216, however, can not be found and, thus, the second row applies and codeset 1 is reaccessed for search. As, however, it is not found therein, codeset 2 is accessed, as shown by arrow F). Here, it is found and after issue the next character 217 is processed successfully from codeset 2, as well.

Then, character 218 is processed and, as it is not found in codeset 2, codeset 1 is reaccessed as shown in the third row in FIG. 3. Character 218 and all subsequent characters remaining in the input set of characters to be converted are found in codeset 1 again. Thus, they are processed as described above and after the last character 230 has been converted, the conversion process stops. Thus, all source character codes have been converted successfully.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

For example, the search can be continued differently after a hit in a rarely used codeset: Alternatively, the search can be continued automatically with the highest priority codeset without trying to find it in the same rarely used codeset. This situation occurs after character 197 has been processed in the above given detailed description. Statistically seen, it can be achieved a further small performance gain.

The present invention can be realized in hardware, software, or a combination of hardware and software. A code conversion tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for converting a source string comprising a plurality of source characters into a target string, the source string being encoded according to a source encoding scheme and the target string being desired to be encoded according to mixed codepages comprising a plurality of sub-codepages, the method comprising the steps of:
associating a predetermined processing priority with each sub-codepage yielding a processing priority sequence; and
converting the characters strictly according to said priority sequence.

2. The method according to claim 1 in which the priority sequence reflects the probability of finding a source character in one of said sub-codepages.

3. The method according to claim 1 further comprising the step of
accessing the sub-codepage having the highest priority which has not yet been accessed for a character if said character has not been found in the current sub-codepage.

4. The method according to claim 1 in which more than one character is processed by a single hardware instruction.

5. The method according to claim 1 in which said priority sequence is dynamically changed from a standard to an individual setting before running the code conversion.

6. A computer system having installed program means for performing the steps of a method according to claim 1.

7. The computer system according to claim 6 arranged for being used as an Internet server having installed program means for performing said method steps.

8. A chip means comprising hardware circuits implementing at least parts of the steps of a method according to claim 1.

9. A device comprising the chip according to claim 8.

10. A computer program for execution in a data processing system comprising computer program code portions for performing respective steps of the method according to claim 1.

11. The computer program according to claim 10 comprising a browser program.

12. A computer program product stored on a computer usable medium comprising computer readable program means for causing a computer to perform the method of claim 1.

13. The method according to claim 1 in which said source encoding scheme is a Unicode encoding scheme.
